(19) United States
(12) Patent Application Publication
(10) Pub. No.: US 2020/0388013 A1
(43) Pub. Date: Dec. 10, 2020

(54) Inverse Matrix Iterative Deconvolution Method for Spectral Resolution Enhancement

(71) Applicant: GUANGXI UNIVERSITY OF SCIENCE AND TECHNOLOGY, LIUZHOU (CN)

(72) Inventors: ZhiXiang YAO, LIUZHOU (CN); Ju YAO, LIUZHOU (CN); Hui SU, LIUZHOU (CN); Liu LIU, LIUZHOU (CN)

(73) Assignee: GUANGXI UNIVERSITY OF SCIENCE AND TECHNOLOGY, LIUZHOU (CN)

(21) Appl. No.: 16/768,210

(22) PCT Filed: May 17, 2019
(86) PCT No.: PCT/CN2019/087440

§ 371 Date: May 29, 2020

(30) Foreign Application Priority Data
May 14, 2019 (CN) 201910396340.3

(51) Int. Cl. G06T 5/00; G06T 5/20; G06T 3/40; G06F 17/16

(52) U.S. Cl. CPC G06T 5/003; G06F 17/16; G06T 3/40; G06T 5/20

(57) ABSTRACT

An inverse matrix iterative deconvolution method for spectral resolution enhancement comprises the following steps: step 1, sequence convolution and convolution square matrices; step 2, cumulative multiplication of convolution square matrices and convolution kernel function peak broadening; and step 3, peak resolution enhancement. The invention achieves the purpose of narrowing the peak width by multiplying primitive functions by deconvolution matrices. Further, the invention provides a method for constructing a deconvolution identity matrix to achieve the deconvolution effect with an expected precision. The calculation process is fast and controllable with stable and accurate results, and the application range is wide. The method can be used for resolution enhancement of molecular spectra such as Raman and infrared spectra, as well as other spectra with symmetrical peak patterns such as mass spectra, nuclear magnetic resonance, XRD and XRF.

### CROSS REFERENCES TO THE RELATED APPLICATIONS

This application is the national phase entry of International Application No. PCT/CN2019/087440, filed on May 17, 2019, which is based upon and claims priority to Chinese Patent Application No. 201910396340.3, filed on May 14, 2019, the entire contents of which are incorporated herein by reference.

### TECHNICAL FIELD

The invention relates to the field of spectral resolution enhancement, in particular to an inverse matrix iterative deconvolution method for spectral resolution enhancement.

### BACKGROUND

Spectra such as Raman, infrared, XRD, XRF and NMR require high resolution. The price of instruments increases significantly with its resolution performance. Therefore, it has always been expected to find a stable, accurate and extensive resolution enhancement algorithm in signal processing.

The essence of resolution reduction is the result of convolution of instruments (e.g., slit, light source or monochromaticity of excitation source, and performance of optical splitter and detector) or other factors (including random broadening of temperature, pressure and Brownian motion) with real signals. When expressed in terms of functions, the observed result is the result of composite convolution of real signals and various convolution kernel functions. Theoretically, a conventional deconvolution method can enhance the resolution as long as proper convolution kernel functions are found.

At present, the most stable and effective deconvolution method is fast Fourier transform (FFT) deconvolution method. Various methods have been developed on the basis. The disadvantage of such methods is that accurate kernel functions have to be defined, but universal kernel functions are difficult to be found which directly affects the universality and accessibility. There are many affecting real data factors. Besides, kernel functions are complex. In fact, it is very difficult to propose universal unified kernel functions. It is also very difficult to solve the problem of resolution enhancement of various instruments on different occasions and to meet the requirements of stability, accuracy and universality.

In response to the difficulty in finding kernel functions, the developed blind deconvolution method can effectively solve the problem of finding kernel functions and can be used for deconvolution with non-strictly consistent results such as image resolution enhancement. However, the method also brings about the problem of result repeatability, which makes it difficult to meet the spectral requirements of strict consistency and result repeatability.

As conventional convolution kernel functions such as Gaussian functions and Lorentz functions still keep their own property of peak width broadening after convolution, while Voigt functions are the convolution of Gaussian and Lorentz functions of different proportions, these functions almost cover the convolution kernel functions of spectra with symmetrical peak patterns, such as Raman, infrared and NMR spectra. The complexity of kernel functions for spectra is mainly caused by different proportions and degrees of broadening of Gaussian functions and Lorentz functions.

Therefore, the invention provides a new convolution and deconvolution implementation method for spectral resolution enhancement. By constructing a convolution square matrix containing tiny units of convolution kernel functions instead of directly defining convolution kernel functions, the convolution square matrix and inverse thereof correspond to convolution and deconvolution respectively. Various convolution kernel functions included with actual peaks can be easily approximated through the constructed convolution square matrix combination multiplication and iterative multiplication, which can be stably, accurately and widely applied to spectral resolution enhancement.

### SUMMARY

In order to solve the problems in the prior art, the purpose of the invention is to provide an inverse matrix iterative deconvolution method for spectral resolution enhancement. By constructing a convolution square matrix containing tiny units of convolution kernel functions instead of directly defining convolution kernel functions, the convolution square matrix and inverse thereof correspond to convolution and deconvolution respectively. Various convolution kernel functions included with actual peaks can be easily approximated through the constructed convolution square matrix combination multiplication and iterative multiplication, which can be stably, accurately and widely applied to spectral resolution enhancement.

To achieve the purpose, the invention adopts the following technical solution:

an inverse matrix iterative deconvolution method for spectral resolution enhancement, comprising the following steps:

### Step 1. Sequence Convolution and Convolution Square Matrices

the convolution results of sequences f(n) and g(n) is:

F(n)=Σ_{i=-∞}^{∞}f(i)g(n−i)=f(n)*g(n) (1)

if f(n) is a spectral sequence containing m values, and the sequence g(n) is truncated to 2m−1 elements, equation (1) is expressed as:

F(n)=Σᵢ₌₋ₘ^{m}f(i)g(n−i) (2)

rewritten in a matrix form as:

$$[ F ( 1 ) … F ( m - 1 ) F ( m ) … F ( 2 m - 1 ) F ( 2 m ) … F ( 3 m - 2 ) ] = \\ [ f ( 1 ) … f ( m ) ] [ \begin{matrix}g ( 1 ) & … & g ( m ) & … & g ( 2 m - 1 ) & & NaN \\ & ⋱ & ⋮ & ⋱ & ⋮ & ⋱ & \\ NaN & & g ( 1 ) & … & g ( m ) & … & g ( 2 m - 1 )\end{matrix} ] \qquad ( 3 )$$

in equation (3), the computable part is reserved, namely:

$$[ \begin{matrix}F ( m ) & … & F ( 2 m - 1 ) ] = [ f ( 1 ) & … & f ( m ) ]\end{matrix} [ \begin{matrix}g ( m ) & … & g ( 2 m - 1 ) \\ ⋮ & ⋱ & ⋮ \\ g ( 1 ) & … & g ( m )\end{matrix} ] \qquad ( 4 )$$

elements of F in equation (4) are renumbered as follows:

$$[ F ( 1 ) … F ( m ) ] = [ f ( 1 ) … f ( m ) ] [ \begin{matrix}g ( m ) & … & g ( 2 m - 1 ) \\ ⋮ & ⋱ & ⋮ \\ g ( 1 ) & … & g ( m )\end{matrix} ] \qquad ( 4 a )$$

considering equation (4a), if convolution kernel g is a symmetric function with a finite peak width, where g(m) is the peak, and the values of b elements before and after the peak tend to 0; and the values of the first and last b elements of the sequence f also tend to zero; then, equation (4) can complete the calculation, and the calculated result is equal to that obtained by equation (2). In other words, equation (4) provided in the invention is a new method to complete convolution by constructing symmetric convolution kernel square matrices, which is expressed in the form of matrix multiplication as follows:

F=f·G (5)

further,

f=F·inv(G) (6)

the meaning of equation (6) is that the known sequence F is multiplied by the inverse of a convolution square matrix to obtain the deconvolution result f.

### Step 2. Cumulative Multiplication of Convolution Square Matrices and Convolution Kernel Function Peak Broadening

taking a Gaussian function as an example, for

$$g ( x ) = \frac{1}{\sqrt{2 π} σ} exp ( - \frac{{x}^{2}}{2 {σ}^{2}} ) \qquad ( 7 )$$

written as:

G⁽¹⁾(y)=Convlve[g(x),g(x),x,y] (8)

then:

$${G}^{( n )} ( y ) = Convlve [ {G}^{( n - 1 )} ( x ) , g ( x ) , x , y ] = \frac{1}{\sqrt{2 ( n + 1 ) π} σ} exp ( - \frac{{x}^{2}}{2 ( n + 1 ) {σ}^{2}} ) \qquad ( 9 )$$

that is, the Gaussian function itself is still a Gaussian function after convolution, and the peak width is increased to \sqrt{n+1} times of convolution number 0.

According to the conclusion, matrix G-chain multiplication is written as:

$${G}^{( n )} = \underbrace{G \cdot G \cdot … \cdot G}_{n + 1} . \qquad ( 10 )$$

As long as the peak width of identity G is small enough, it only needs to adjust n to approximate to the convolution and deconvolution requirements with the required precision. It is only required to replace the sequence g(n) in G for different convolution kernel functions.

### Step 3. Peak Resolution Enhancement

Peak width is a main factor affecting the resolution, the resolution can be enhanced by narrowing the peak width (half peak width, FWM) to identify overlapping peaks. Equation (9) indicates that forward convolution leads to peak broadening, while reverse convolution can achieve peak narrowing, corresponding deconvolution kernel function identity matrices can be constructed according to equations (6) and (10), and deconvolution kernel function matrices with required precision can be obtained through iterative calculation.

Further, the method comprises the following specific steps:

step 1. generating identity convolution and deconvolution matrices

1) entering the spectral sequence value peak f(n) to be processed, with a plurality of flat data points without peaks reserved or added in front and back;

2) determining a distribution function for deconvolution according to the number m of elements in f(n) and the nature of peaks in f;

3) determining the peak width (full width at half maximum) of the distribution function according to the requirements of calculating precision, which can be selected from 0.1 to 1;

4) generating a sequence g(n), wherein the number of elements is 2m-1, and the peak is located at the mth element; placing the g(n) sequence value in line 1, and sequentially translating backward to generate line 2, . . . , until line m, and replacing missing elements in the translation by 0 or ‘NaN’ to obtain a matrix M with a size of m×(3m−2);

5) cutting out column m through column 2m−1 from M to obtain an m×m square matrix which is an identity convolution matrix G; and

6) inversing G to obtain an identity deconvolution matrix IG.

The generated identity convolution and deconvolution matrices are diagonally symmetric matrices, for spectral sequences with different number of elements, it is not necessary to generate the matrices every time, an identity matrix with a large number of elements is generated first, and square matrices with the corresponding sizes are intercepted from the large matrix when required later;

step 2. enhancing spectral resolution by using the deconvolution matrix

1) selecting spectral peaks that require resolution enhancement; for a Raman or infrared spectrum, as a result of inconsistent peak broadening at different wave numbers, selecting the part that requires resolution enhancement from a complete spectrogram and reserving a portion of head-and-tail baseline as much as possible to ensure stable and accurate resolution enhancement;

2) selecting the type of the deconvolution kernel function; judging and selecting main factors affecting broadening according to peak pattern and width; and checking the resolution enhancement result by random or enumeration trials if it is impossible to make judgment or without prior knowledge;

3) defining the sequence peak width of the identity convolution matrix according to the requirement of peak splitting precision to generate the identity deconvolution matrix;

4) for the entered parent peak F, according to f=F·inv(G⁽ⁿ⁾) or f=F·IG⁽ⁿ⁾, where IG(n) is similar to G(n), that is:

$${IG}^{( n )} = \underbrace{IG \cdot IG \cdot … \cdot IG}_{n + 1} ,$$

calculating the resolution enhancement peak f after deconvolution;

5) increasing n for iteration, stopping calculation when the peak width is narrowed to the overlapping peak to meet the identification requirements, or continuing calculation until the signal-to-noise ratio of a signal reaches the tolerable limit of users.

It should be noted that the resolution is closely related to the signal-to-noise ratio of the signal, and the resolution enhancement is actually the conversion of signal frequency from a low frequency to a high frequency, due to resolution enhancement, low frequency noise originally hidden in the signal will also manifests as significant high frequency noise, resulting in deterioration of the signal-to-noise ratio. In order to lower the limit of the signal-to-noise ratio, a signal with good signal-to-noise ratio should be selected for resolution enhancement. The deconvolution resolution enhancement of the invention is a gradual process, thus smooth noise reduction can be interspersed in the process as appropriate to improve the signal-to-noise ratio of the output result.

Further, in step 1) of the step 1, more than 10 data points are reserved in front and back respectively so as to be discarded in the final result.

Further, in step 2) of the step 1, the distribution function is specifically Gaussian distribution and Lorentz distribution.

Further, in step 6) of the step 1, specifically:

a large matrix G(m×m) with m×m elements has been generated, it is only required to intercept G(p×p) from G(m×m) if p×p elements (p<m) are required; and the matrix G and subsets thereof can be written as:

$$[ \begin{matrix}g ( m ) & & … & g ( m - p + 1 ) & … & g ( 1 ) \\ ⋮ & & ⋱ & ⋮ & & ⋮ \\ \underbrace{g ( m - p + 1 )} & & \underbrace{…}_{p \times p} & \underbrace{g ( m )} & & ⋮ \\ ⋮ & & & & ⋱ & ⋮ \\ \underbrace{g ( 1 )} & \underbrace{…} & \underbrace{…} & & \underbrace{…} & \underbrace{g ( m )}_{m \times m}\end{matrix} ] . \qquad ( 11 )$$

Compared with the prior art, the invention has the following beneficial effects:

The invention can achieve the purpose of narrowing the peak width by multiplying primitive functions by deconvolution matrices. Further, the invention provides a method for constructing a deconvolution identity matrix to achieve the deconvolution effect with an expected precision. The calculation process is fast and controllable, with stable and accurate results, and wide range of application. The method can be used for resolution enhancement of molecular spectra such as Raman and infrared spectra, as well as other spectra with symmetrical peak patterns such as mass spectra, nuclear magnetic resonance, XRD and XRF. Taking a Raman spectrum for example, the example gives the implementation steps and effects achieved.

### BRIEF DESCRIPTION OF THE DRAWINGS

FIG. 1 is a Raman spectrum of toluene.

FIG. 2 is a Raman spectrum of toluene at 900-1100cm⁻¹ wave numbers.

FIG. 3 is an effect diagram of matrix iterative deconvolution for spectral resolution enhancement using Lorentz kernel functions.

FIG. 4 is an effect diagram of matrix iterative deconvolution for spectral resolution enhancement using Gaussian kernel functions.

FIG. 5 shows the contrast between the parent peak of CCl₄ and the peak after resolution enhancement.

FIG. 6 shows the measurement results of a large long-focus Raman spectrometer.

### DETAILED DESCRIPTION OF THE EMBODIMENTS

The technical solution of the invention will be further described in combination with accompanying drawings and preferred embodiments.

### Implementation Steps

### 1. Generating Identity Convolution and Deconvolution Matrices

1) entering the spectral sequence value peak f(n) to be processed, with a plurality of flat data without peaks reserved or added in front and back, generally more than 10 data points reserved in front and back respectively so as to be discarded in the final result;

2) determining a distribution function for deconvolution according to the number m of elements in f(n) and the nature of peaks in f, such as Gaussian distribution and Lorentz distribution;

3) determining the peak width (full width at half maximum) of the distribution function according to the requirements of calculating precision, which can be selected from 0.1 to 1;

4) generating a sequence g(n), wherein the number of elements is 2m-−1, and the peak is located at the mth element; placing the g(n) sequence value in line 1, and sequentially translating backward to generate line 2, . . . , until line m, and replacing missing elements in the translation by 0 or ‘NaN’ to obtain a matrix M with a size of m×(3m−2);

5) cutting out column m through column 2m−1 from M to obtain an m×m square matrix which is an identity convolution matrix G; and

6) inversing G to obtain an identity deconvolution matrix IG.

It should be noted that the generated identity convolution and deconvolution matrices are diagonally symmetric matrices. That is, for spectral sequences with different number of elements, it is not necessary to generate the matrices every time, an identity matrix with a large number of elements is generated first, and square matrices with the corresponding sizes are intercepted from the large matrix when required later.

For example, a large matrix G(m×m) with m×m elements has been generated, it is only required to intercept G(p×p) from G(m×m) ^{if p×p} elements (p<m) are required. The matrix G and subsets thereof can be written as:

$$[ \begin{matrix}g ( m ) & & … & g ( m - p + 1 ) & … & g ( 1 ) \\ ⋮ & & ⋱ & ⋮ & & ⋮ \\ \underbrace{g ( m - p + 1 )} & & \underbrace{…}_{p \times p} & \underbrace{g ( m )} & & ⋮ \\ ⋮ & & & & ⋱ & ⋮ \\ \underbrace{g ( 1 )} & \underbrace{…} & \underbrace{…} & & \underbrace{…} & \underbrace{g ( m )}_{m \times m}\end{matrix} ] \qquad ( 11 )$$

### 2. Enhancing Spectral Resolution by Using the Deconvolution Matrix

1) Selecting spectral peaks that require resolution enhancement. For a Raman or infrared spectrum, as a result of inconsistent peak broadening at different wave numbers, selecting the part that requires resolution enhancement from a complete spectrogram and reserving a portion of head-and-tail baseline as much as possible to ensure stable and accurate resolution enhancement.

2) Selecting the type of the deconvolution kernel function. Judging and selecting main factors affecting broadening according to peak pattern and width. Checking the resolution enhancement result by random or enumeration trials if it is impossible to make judgment or without prior knowledge.

3) Defining the sequence peak width of the identity convolution matrix according to the requirement of peak splitting precision to generate the identity deconvolution matrix.

4) For the entered parent peak F, according to f=F·inv(G⁽ⁿ⁾) or f=F·IG⁽ⁿ⁾, where IG(n) is similar to G(n), that is:

$${IG}^{( n )} = \underbrace{IG \cdot IG \cdot … \cdot IG}_{n + 1} ,$$

calculating the resolution enhancement peak f after deconvolution.

5) Increasing n for iteration, stopping calculation when the peak width is narrowed to the overlapping peak to meet the identification requirements, or continuing calculation until the signal-to-noise ratio of a signal reaches the tolerable limit of users.

It should be noted that the resolution is closely related to the signal-to-noise ratio of the signal, and the resolution enhancement is actually the conversion of signal frequency from a low frequency to a high frequency, due to resolution enhancement, low frequency noise originally hidden in the signal will also manifests as significant high frequency noise, resulting in deterioration of the signal-to-noise ratio. In order to lower the limit of the signal-to-noise ratio, a signal with good signal-to-noise ratio should be selected for resolution enhancement. The deconvolution resolution enhancement of the invention is a gradual process, thus smooth noise reduction can be interspersed in the process as appropriate to improve the signal-to-noise ratio of the output result

### Example

Taking a Raman spectrum of toluene as an example.

FIG. 1 is a Raman spectrum of toluene.

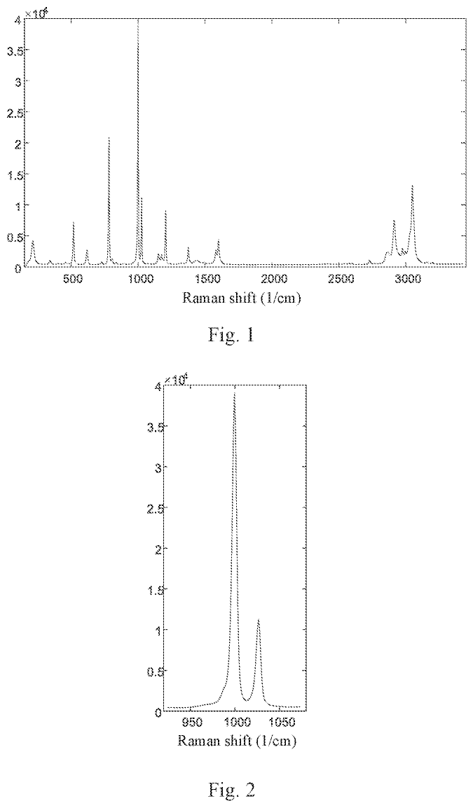

1. The Raman spectrum F of toluene at 900-1100cm⁻¹ wave numbers is taken as an example of resolution enhancement by deconvolution, as shown in FIG. 2.

2. The number of pixels in the spectral band is 121, i.e., the number m of elements in f(n) is 121. The contribution of a Lorentz function in the Voigt peak can be eliminated by deconvolution of the Lorentz function.

3. The unit peak width of Lorentz peak is determined to be 0.1 according to the requirements of calculation precision.

4. A sequence g(n) is generated according to the Lorentz function, in which the number of elements is 2m−1 and the peak center is located at the mth element. The g(n) sequence value is placed in line 1, and sequentially translated backward to generate line 2, . . . , until line m, and missing elements in the translation are replaced by 0 or ‘NaN’ to obtain a matrix M with a size of m×(3m−2).

5. Column m through column 2m−1 are cut out from M to obtain an m×m square matrix which is an identity convolution matrix G.

6. G is inversed to obtain the identity deconvolution matrix IG.

7. For the entered parent peak F, according to f=F·inv(G⁽ⁿ⁾) or f=F·IG⁽ⁿ⁾, where IG(n) is similar to G ( ), that is,

$${IG}^{( n )} = \underbrace{IG \cdot IG \cdot … \cdot IG}_{n + 1} ,$$

the resolution enhancement peak f after deconvolution is calculated. The n is increasing for iteration.

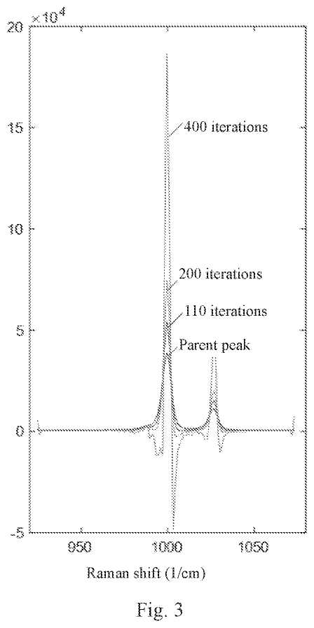

FIG. 3 shows the effects of the parent peak, 110 iterations, 200 iterations and 400 iterations respectively. The parent peak at 999 wave numbers and the full width at half maximum (FWHM) after Lorentz deconvolution for 110 times are 6.09 and 4.79 respectively, and the parent peak at 1027 wave numbers and the FWHM after processing are 6.51 and 5.13 respectively.

In FIG. 3, there is no distortion of the peak pattern after 110 iterations. Continuous deconvolution of the Lorentz peak will distort the peak pattern, indicating that the Lorentz peak has been eliminated in 110 iterations.

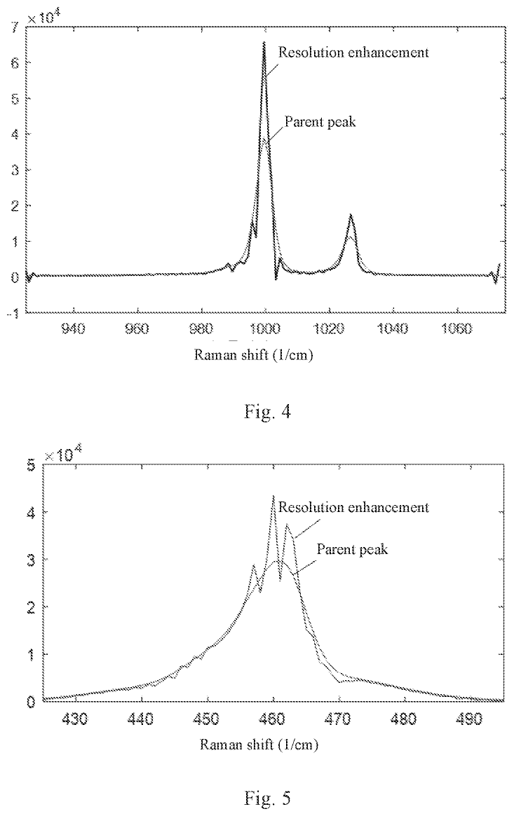

8. Deconvolution kernel functions are further selected as Gaussian functions for deconvolution for spectral resolution enhancement. The steps of generating a Gaussian deconvolution matrix are the same as previous steps 3-7, in which relevant parameters are changed as follows, g(n) is changed to a Gaussian function, the unit peak width is 0.5, 65,000 iterations are performed, and the resolution enhancement result is shown in FIG. 4. The FWHM of two main peaks in the figure are 2.63 and 3.07 respectively, which is cut by more than half compared with the parent peak. More importantly, the weak peak originally overlapped in the main peak at 999 wave numbers is clearly identified.

The resolution enhancement proposed by the invention can keep the nature of peaks well, and obviously enhance the identification ability of overlapping peaks.

Overlapping multiple peaks in CCl₄ spectra measured by an ordinary Raman spectrometer with a resolution of 6 cm⁻¹ are also identified to verify the accuracy and effectiveness of the method. Parameters used for deconvolution are as follows: select the Lorentz peak width 0.1 for 100 iterations, and then select the Gaussian peak width 0.5 for 35,000 iterations.

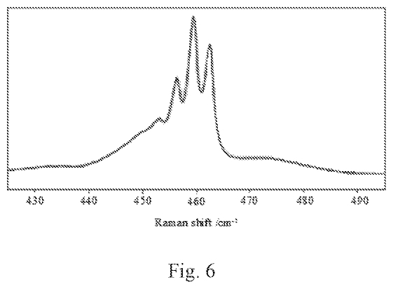

FIG. 5 shows the contrast between the parent peak of CCl₄ and the peak after resolution enhancement. FIG. 6 shows the measurement results of a large long-focus Raman spectrometer.

The above example is only a preferred embodiment of the invention, and the protection scope of the invention is not limited to this. Any changes or replacements without creative labor shall fall within the protection scope of the invention. Therefore, the protection scope of the invention should be subject to the protection scope defined by the claims.

What is claimed is:

1. An inverse matrix iterative deconvolution method for spectral resolution enhancement, comprising the following steps:
step 1. sequence convolution and convolution square matrices
convolution results of sequences f(n) and g(n) being:
F(n)=Σ_{i=-∞}^{∞}f(i)g(n−i)=f(n)*g(n) (1)
when the sequence f(n) is a spectral sequence containing m values, and the sequence g(n) is truncated to 2m−1 elements, equation (1) is expressed as:
F(n)=Σᵢ₌₋ₘ^{m}f(i)g(n−i) (2)
rewritten in a matrix form as:
$$[ F ( 1 ) … F ( m - 1 ) F ( m ) … F ( 2 m - 1 ) F ( 2 m ) … F ( 3 m - 2 ) ] = [ f ( 1 ) … f ( m ) ] [ \begin{matrix}g ( 1 ) & … & g ( m ) & … & g ( 2 m - 1 ) & & NaN \\ & ⋱ & ⋮ & ⋱ & ⋮ & ⋱ & \\ NaN & & g ( 1 ) & … & g ( m ) & … & g ( 2 m - 1 )\end{matrix} ] \qquad ( 3 )$$
in equation (3), a computable part is reserved, namely:
$$[ F ( m ) … F ( 2 m - 1 ) ] = [ f ( 1 ) … f ( m ) ] [ \begin{matrix}g ( m ) & … & g ( 2 m - 1 ) \\ ⋮ & ⋱ & ⋮ \\ g ( 1 ) & … & g ( m )\end{matrix} ] \qquad ( 4 )$$
elements of F in equation (4) being renumbered as follows:
$$[ F ( 1 ) … F ( m ) ] = [ f ( 1 ) … f ( m ) ] [ \begin{matrix}g ( m ) & … & g ( 2 m - 1 ) \\ ⋮ & ⋱ & ⋮ \\ g ( 1 ) & … & g ( m )\end{matrix} ] \qquad ( 4 a )$$
considering equation (4a), if a convolution kernel g is a symmetric function with a finite peak width, where g(m) is a peak, and values of b elements before and after the peak tend to 0; and the values of a first and last b elements of the sequence f(n) also tend to zero; then, equation (4) completes a calculation, and a calculated result is equal to that obtained by equation (2); in other words, equation (4) is a method to complete convolution by constructing symmetric convolution kernel square matrices; wherein constructing the symmetric convolution kernel square matrices is expressed in a form of matrix multiplication as follows:
F=f·G (5)
further,
f=F·inv(G) (6)
a meaning of equation (6) being that a known sequence F is multiplied by an inverse of a convolution square matrix of the convolution square matrices to obtain a deconvolution result f;
step 2. cumulative multiplication of the convolution square matrices and a convolution kernel function peak broadening
taking a Gaussian function as an example, for
$$g ( x ) = \frac{1}{\sqrt{2 π} σ} exp ( - \frac{{x}^{2}}{2 {σ}^{2}} ) \qquad ( 7 )$$
written as:
G⁽¹⁾(y)=Convlve[g(x),g(x),x,y] (8)
then:
$${G}^{( n )} ( y ) = Convlve [ {G}^{( n - 1 )} ( x ) , g ( x ) , x , y ] = \frac{1}{\sqrt{2 ( n + 1 ) π} σ} exp ( - \frac{{x}^{2}}{2 ( n + 1 ) {σ}^{2}} ) \qquad ( 9 )$$
the Gaussian function is still the Gaussian function after convolution, and a peak width is increased to \sqrt{n+1} times of convolution number n;
according to a conclusion, a matrix G-chain multiplication is written as:
$${G}^{( n )} = \underbrace{G \cdot G \cdot … \cdot G}_{n + 1} \qquad ( 10 )$$
as long as the peak width of an identity G is small enough, the matrix G-chain multiplication only needs to adjust n to approximate to a plurality of convolution and deconvolution requirements with a required precision, and the matrix G-chain multiplication only required to replace the sequence g(n) in G for different convolution kernel functions;
step 3. peak resolution enhancement
the peak width is a main factor affecting a resolution, the resolution is enhanced by narrowing the peak width to identify a plurality of overlapping peaks; equation (9) indicates a forward convolution leads to peak broadening, while a reverse convolution achieves peak narrowing, corresponding deconvolution kernel function identity matrices are constructed according to equations (6) and (10), and deconvolution kernel function matrices with the required precision are obtained through an iterative calculation.

2. The method according to claim 1, wherein the method comprises the following specific steps:
step 1. generating identity convolution and deconvolution matrices 1) entering a spectral sequence value peak f(n) to be processed, with a plurality of flat data points without peaks reserved or added in front and back;
2) determining a distribution function for deconvolution according to a number m of elements in the spectral sequence value peak f(n) and a nature of peaks in f;
3) determining the peak width (full width at half maximum) of the distribution function according to a plurality of requirements of calculating precision, wherein the peak width is selected from 0.1 to 1;
4) generating the sequence g(n), wherein a number of elements is 2m−1, and the peak is located at an mth element; placing a g(n) sequence value in line 1, and sequentially translating backward to generate line 2, . . . , until line m, and replacing missing elements in a translation by 0 or ‘NaN’ to obtain a matrix M with a size of m×(3m−2);
5) cutting out a column m through a column 2m−1 from M to obtain an m×m square matrix, wherein the m×m square matrix is an identity convolution matrix G; and
6) inversing the identity convolution matrix G to obtain an identity deconvolution matrix IG;
wherein generated identity convolution and deconvolution matrices are diagonally symmetric matrices, for spectral sequences with different number of elements, the identity convolution and deconvolution matrices are not necessary to be generated every time, an identity matrix with a large number of elements is generated first, and a plurality of square matrices with corresponding sizes are intercepted from a large matrix when required later;
step 2. enhancing spectral resolution by using a deconvolution matrix
1) selecting a plurality of spectral peaks that require resolution enhancement; for a Raman or infrared spectrum, as a result of inconsistent peak broadening at different wave numbers, selecting a part that requires the resolution enhancement from a complete spectrogram and reserving a portion of head-and-tail baseline as much as possible to ensure stable and accurate resolution enhancement;
2) selecting a type of the deconvolution kernel function; judging and selecting main factors affecting broadening according to a peak pattern and the peak width; and checking a resolution enhancement result by random or enumeration trials when impossible to make judgment or without prior knowledge;
3) defining a sequence peak width of the identity convolution matrix according to a requirement of peak splitting precision to generate the identity deconvolution matrix;
4) for an entered parent peak F, according to f=F·inv(G⁽ⁿ⁾) or f=F·IG⁽ⁿ⁾, where IG(n) is similar to G(n), that is:
$${IG}^{( n )} = \underbrace{IG \cdot IG \cdot … \cdot IG}_{n + 1} ,$$
calculating a resolution enhancement peak f after deconvolution;
5) increasing n for iteration, stopping calculation when the peak width is narrowed to an overlapping peak to meet a plurality of identification requirements, or continuing calculation until a signal-to-noise ratio of a signal reaches a tolerable limit of a plurality of users;
the resolution is related to the signal-to-noise ratio of the signal, and the resolution enhancement is actually a conversion of a signal frequency from a low frequency to a high frequency, due to the resolution enhancement, a low frequency noise originally hidden in the signal will also manifests as a significant high frequency noise, resulting in deterioration of the signal-to-noise ratio; in order to lower a limit of the signal-to-noise ratio, a signal with a good signal-to-noise ratio is selected for the resolution enhancement;
a deconvolution resolution enhancement of the inverse matrix iterative deconvolution method for spectral resolution enhancement is a gradual process, thus smooth noise reduction is interspersed in the process as appropriate to improve the signal-to-noise ratio of an output result.

3. The method according to claim 2, wherein in step 1) of the step 1, more than 10 data points are reserved in front and back respectively so as to be discarded in a final result.

4. The method according to claim 2, wherein in step 2) of the step 1, the distribution function is specifically a Gaussian distribution and a Lorentz distribution.

5. The method according to claim 2, wherein in step 6) of the step 1, specifically:
a large matrix G(m×m) with m×m elements has been generated, interception of G(p×p) from G(m×m) is only required when p×p elements (p<m) are required; and the large matrix G and subsets of the large matrix is written as:
$$[ \begin{matrix}g ( m ) & & … & g ( m - p + 1 ) & … & g ( 1 ) \\ ⋮ & & ⋱ & ⋮ & & ⋮ \\ \underbrace{g ( m - p + 1 )} & & \underbrace{…}_{p \times p} & \underbrace{g ( m )} & & ⋮ \\ ⋮ & & & & ⋱ & ⋮ \\ \underbrace{g ( 1 )} & \underbrace{…} & \underbrace{…} & & \underbrace{…} & \underbrace{g ( m )}_{m \times m}\end{matrix} ] . \qquad ( 11 )$$
